(19) United States
(12) Patent Application Publication
(10) Pub. No.: US 2026/0055282 A1
(43) Pub. Date: Feb. 26, 2026

(54) PHOTOCATALYTIC COATING LIQUID AND PHOTOCATALYTIC SPRAY CAN

(71) Applicant: SHARP KABUSHIKI KAISHA, Osaka (JP)

(72) Inventors: TOMOYA TSUTSUMINO, Osaka (JP); Yoshitaka Kawase, Osaka (JP); Naoki Shiba, Osaka (JP); Yoshiki Kato, Osaka (JP); Tatsufumi Atsumi, Osaka (JP)

(21) Appl. No.: 19/302,422

(22) Filed: Aug. 18, 2025

(30) Foreign Application Priority Data
Aug. 26, 2024 (JP) 2024-144543

(51) Int. Cl. C09D 7/61; B65D 83/141

(52) U.S. Cl. CPC C09D 7/61; B65D 83/141

(57) ABSTRACT

A photocatalytic coating liquid of the disclosure contains: 1.0 wt. % or more and 5.0 wt. % or less of photocatalytic particles; 0.05 wt. % or more and 0.5 wt. % or less of a binder; a metal ion; and an aqueous dispersion medium, wherein the photocatalytic particles include tungsten oxide particles, an average particle size of primary particles is 10 nm or more and 50 nm or less, the average particle size being converted from a BET specific surface area of the photocatalytic particles using a true spherical model, and an average particle size D50 of secondary particles of the photocatalytic particles is 600 μm or more and 1000 μm or less.

### INCORPORATION BY REFERENCE

This application is based upon and claims the benefit of priority from the corresponding Japanese Patent Application No. 2024-144543 filed on Aug. 26, 2024, the entire contents of which are incorporated herein by reference.

### BACKGROUND

The disclosure relates to a photocatalytic coating liquid and a photocatalytic spray can.

There is known a method for forming a photocatalyst layer by applying a photocatalytic coating liquid containing photocatalytic particles and a binder onto a base material. The photocatalytic particles contained in the photocatalyst layer produced by such a method are fixed by the binder and are less likely to be detached from the photocatalyst layer. Thus, the photocatalyst layer has contact resistance and can have photocatalytic activity over a long period of time.

### SUMMARY

The disclosure provides a photocatalytic coating liquid containing 1.0 wt. % or more and 5.0 wt. % or less of photocatalytic particles, 0.05 wt. % or more and 0.5 wt. % or less of a binder, a metal ion, and an aqueous dispersion medium,
in which
the photocatalytic particles contain tungsten oxide particles,
an average particle size of primary particles is 10 nm or more and 50 nm or less, the average particle size being converted from a BET specific surface area of the photocatalytic particles using a true spherical model, and
an average particle size D50 of secondary particles of the photocatalytic particles is 600 μm or more and 1000 μm or less.

The photocatalyst layer formed by using the photocatalytic coating liquid of the disclosure has excellent contact resistance and high photocatalytic activity. This has been demonstrated by experiments conducted by the inventors of the present application.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an explanatory view of a method for forming a photocatalyst layer using a photocatalytic coating liquid according to an embodiment of the disclosure.

FIG. 2 is a graph showing a change in secondary particle size of the photocatalytic particles with respect to a concentration of a copper ion contained in the photocatalytic coating liquid.

FIG. 3 is a graph showing a change in gas removal rate with respect to the concentration of the copper ion contained in the photocatalytic coating liquid.

FIG. 4 provides Table 1 showing proportions of components contained in photocatalytic coating liquids.

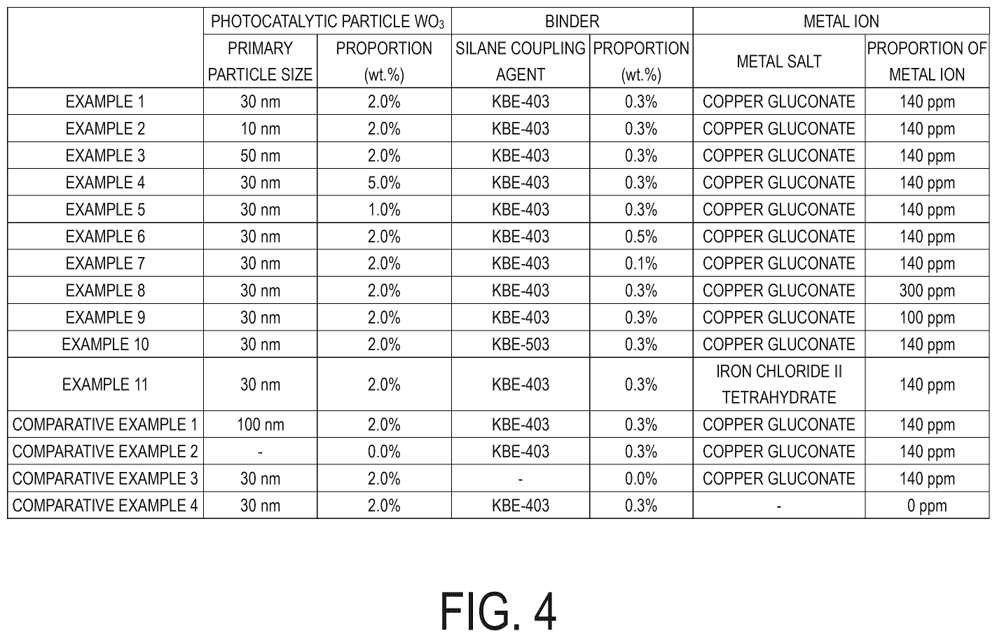

FIG. 5 provides Table 2 showing copper ion concentrations contained in photocatalytic coating liquids, secondary particle sizes of photocatalytic particles contained in the photocatalytic coating liquids, and gas decomposition characteristics of the photocatalytic coating liquids.

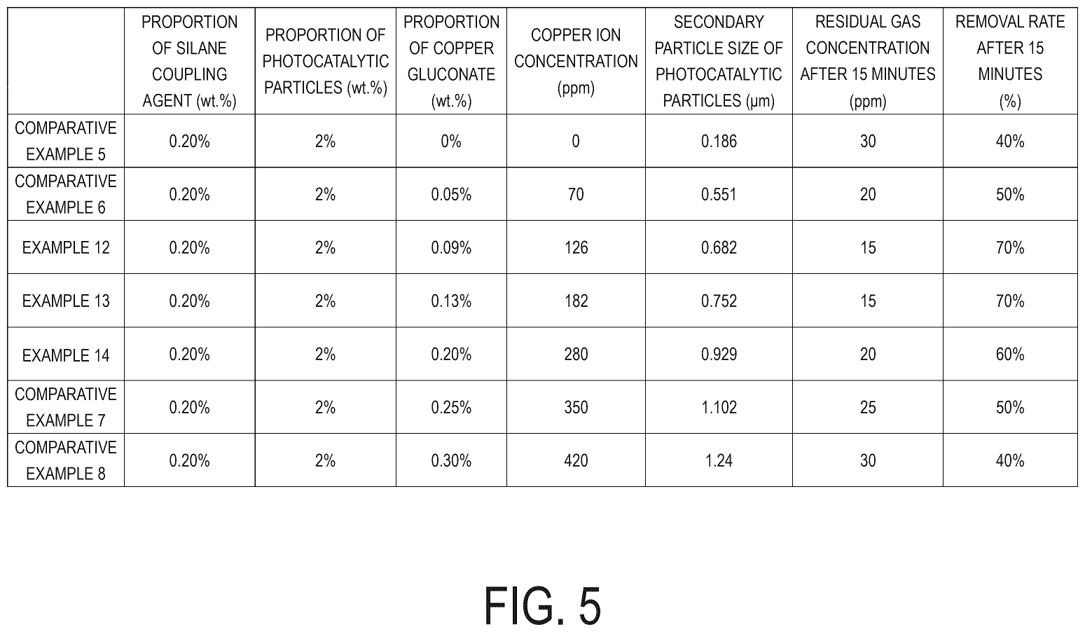

FIG. 6 provides Table 3 showing secondary particle sizes of the photocatalytic particles contained in the photocatalytic coating liquids, gas decomposition characteristics of the photocatalytic coating liquids, and contact resistances of the photocatalytic coating liquids.

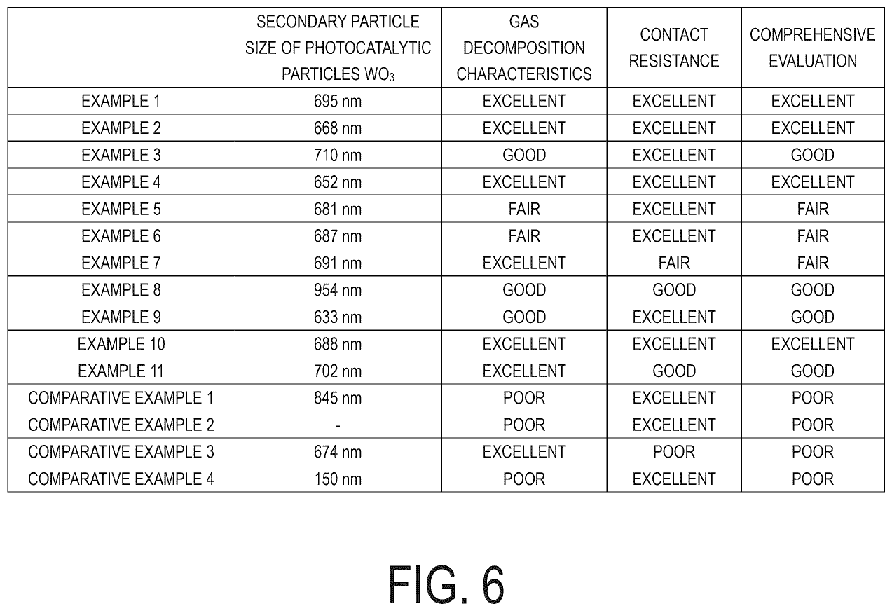

### DETAILED DESCRIPTION

A photocatalytic coating liquid of the disclosure contains 1.0 wt. % or more and 5.0 wt. % or less of photocatalytic particles, 0.05 wt. % or more and 0.5 wt. % or less of a binder, a metal ion, and an aqueous dispersion medium, in which the photocatalytic particles contain tungsten oxide particles, an average particle size of primary particles is 10 nm or more and 50 nm or less, the average particle size being converted from a BET specific surface area of the photocatalytic particles using a true spherical model, and an average particle size D50 of secondary particles of the photocatalytic particles is 600 μm or more and 1000 μm or less.

The concentration of the metal ion in the photocatalytic coating liquid is preferably 100 ppm or more and 300 ppm or less.

The binder preferably has an inorganic skeleton composed of a siloxane bond or a silanol group.

The metal ion preferably includes at least one of a copper ion, a silver ion, an iron ion, and a zinc ion.

The disclosure also provides a photocatalytic spray can including: the photocatalytic coating liquid of the disclosure; a propellant; and a spray container that stores the photocatalytic coating liquid and the propellant, in which the spray container has a spray hole provided to spray the photocatalytic coating liquid together with the propellant. Preferably, the propellant contains dimethyl ether, the hole diameter of the spray hole is 0.3 mm or less, and the internal pressure of the spray container is 0.4 MPa or more at a temperature of 25° C.

An embodiment of the disclosure will be described below with reference to the drawings. Configurations illustrated in the drawings and presented in the following description are examples, and the scope of the disclosure is not limited to the configurations illustrated in the drawings or presented in the following description.

### Photocatalytic Coating Liquid and Photocatalyst Layer

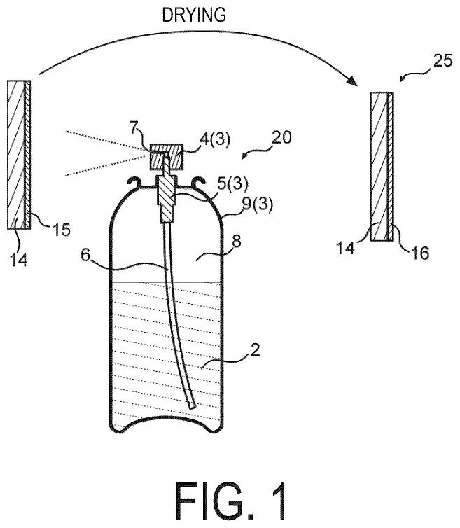

FIG. 1 is an explanatory view of a method for forming a photocatalyst layer using a photocatalytic coating liquid of the present embodiment.

A photocatalytic coating liquid 2 of the present embodiment includes 1.0 wt. % or more and 5.0 wt. % or less of photocatalytic particles, 0.05 wt. % or more and 0.5 wt. % or less of a binder, a metal ion, and an aqueous dispersion medium, in which the photocatalytic particles contain tungsten oxide particles, an average particle size of primary particles is 10 nm or more and 50 nm or less, the average particle size being converted from a BET specific surface area of the photocatalytic particles using a true spherical model, and an average particle size D50 of secondary particles of the photocatalytic particles is 600 μm or more and 1000 μm or less.

The photocatalytic coating liquid 2 is a dispersion liquid for forming a photocatalyst layer 16 on the surface of a target (for example, a base material 14) by a coating method, and is a suspension in which the photocatalytic particles are dispersed in the aqueous dispersion medium in which a metal salt (metal ion) and the binder are dissolved. The photocatalytic coating liquid may contain a dispersant, porous particles, and the like. The photocatalytic coating liquid may be a photocatalytic spray liquid. The photocatalytic coating liquid 2 may be acidic.

The photocatalytic coating liquid 2 can be prepared, for example, as follows. (1) Photocatalytic particles (powder or slurry) are dispersed in water to prepare a dispersion (if necessary, a dispersant is added together). (2) A binder is mixed into the dispersion. (3) A metal salt as a source of a metal ion is mixed and dissolved in the dispersion. The photocatalytic particles can be dispersed in water generally by using a wet disperser, and examples of the disperser include an ultrasonic disperser, a colloid mill, and a bead mill.

For the mixing, a general liquid mixer can be used. A mixer equipped with a stirring blade or the like can make the composition of the photocatalytic coating liquid 2 more uniform.

The method of applying the photocatalytic coating liquid 2 onto the target is not particularly limited, and examples thereof include spray coating, dip coating, spin coating, bar coating, brush coating, roller brush coating, roll coater coating, and curtain flow coater coating. In the example illustrated in FIG. 1, the photocatalytic coating liquid 2 is spray-applied onto the base material 14 using a spray container 3 (aerosol container) to form a coating film 15, and the coating film 15 is dried to form the photocatalyst layer 16.

The aqueous dispersion medium is water or an aqueous solution, and is a medium in which the photocatalytic particles are dispersed. The aqueous dispersion medium is, for example, an aqueous solution, an ethanol aqueous solution, or the like, in which the metal salt, the binder, and the like are dissolved.

The photocatalytic particles contained in the photocatalytic coating liquid 2 are particles or powder, which become photocatalytically active by receiving light. The photocatalytic particles include tungsten oxide particles (WO₃ particles). The tungsten oxide particles may be tungsten oxide particles having a composition deviating from a stoichiometric composition as long as the tungsten oxide particles have photocatalytic activity. The tungsten oxide particles may contain impurity atoms or additive atoms within a range in which photocatalytic activity is not lost. Photocatalytic particles may each have a promoter on a surface thereof. Examples of the promoter include platinum group metals such as Pt, Pd, Rh, Ru, Os, and Ir.

A proportion of the photocatalytic particles in the photocatalytic coating liquid 2 is 1.0 wt. % or more and 5.0 wt. % or less, and preferably 1.5 wt. % or more and 5.0 wt. % or less. An average particle size of primary particles is 10 nm or more and 50 nm or less, the average particle size being converted from a BET specific surface area of the photocatalytic particles contained in the photocatalytic coating liquid 2 using a true spherical model. This can increase a surface area of the photocatalytic particles in the photocatalyst layer 16, allowing the photocatalyst layer 16 to have high photocatalytic activity. For example, the photocatalytic coating liquid 2 is dried to obtain a powder of the photocatalytic particles, and the specific surface area of the powder is measured by using the BET method. An average particle size of the primary particles of the photocatalytic particles can be calculated from the measurement result. As a measuring apparatus, a general apparatus can be used, and examples thereof include an all-in-one BET specific surface area and pore size analyzer NOVA series available from Anton Paar GmbH.

An average particle size D50 of secondary particles of the photocatalytic particles contained in the photocatalytic coating liquid 2 is 600 μm or more and 1000 μm or less. When the average particle size of the secondary particles of the photocatalytic particles is set to 600 μm or more, it is possible to suppress that the photocatalytic particles are buried in the binder in the photocatalyst layer 16, and thus, the photocatalyst layer 16 can have high photocatalytic activity. In addition, when the average particle size of the secondary particles of the photocatalytic particles is set to 1000 μm or less, it is possible to cause many of the primary particles constituting the secondary particles to generate photocatalytic activity, and thus, the photocatalyst layer 16 can have high photocatalytic activity.

The average particle size D50 of the secondary particles of the photocatalytic particles contained in the photocatalytic coating liquid 2 can be obtained by measuring the photocatalytic coating liquid 2 with a laser diffraction/scattering particle size distribution measuring apparatus. As the measuring apparatus, a general measurement apparatus can be used, and examples thereof include Microtrac MT3000 II Series available from MicrotracBEL Corp.

The binder contained in the photocatalytic coating liquid 2 is not particularly limited, and examples thereof include a hydrolysate of a silane coupling agent, a dehydration condensate of a hydrolysate of a silane coupling agent, a hydrolysate of tetraalkoxysilane, a dehydration condensate of a hydrolysate of tetraalkoxysilane, a silicone-based resin, an epoxy resin, a urethane resin, a phenol resin, an acrylic resin, a styrene resin, a polyamide, a polyester, an acetal resin, a polycarbonate, a vinyl chloride resin, a vinyl acetate resin, a cellulose resin, a polyolefin, a copolymer resin thereof, and a blended resin. The binder contained in the photocatalytic coating liquid 2 preferably has an inorganic skeleton composed of a siloxane bond or a silanol group. Such a binder is resistant to light and heat and is less likely to be decomposed by photocatalytic activity.

Examples of the binder having an inorganic skeleton composed of a siloxane bond include a silicone-based resin, a dehydration condensate of a hydrolysate of a silane coupling agent, and a dehydration condensate of a hydrolysate of tetraalkoxysilane. The dehydration condensate can be produced by, for example, mixing a silane coupling agent or tetraalkoxysilane with water to cause a hydrolysis reaction to proceed, and causing a dehydration reaction between two silanol groups produced by the hydrolysis reaction to proceed. Such a dehydration condensate is a compound having an inorganic skeleton composed of a siloxane bond. The dehydration condensate may be produced by using a silane coupling agent or tetraalkoxysilane as a raw material of the photocatalytic coating liquid 2 and causing a hydrolysis reaction and a dehydration reaction to proceed in the preparation of the photocatalytic coating liquid 2. An alcohol produced by the hydrolysis reaction may be contained in the photocatalytic coating liquid 2.

Examples of the binder having a silanol group include a hydrolysate of a silane coupling agent and a hydrolysate of tetraalkoxysilane.

The hydrolyzate can be produced by mixing a silane coupling agent or tetraalkoxysilane with water to cause a hydrolysis reaction to proceed. Such a hydrolyzate is a compound having a silanol group. The hydrolyzate may be produced by using a silane coupling agent or tetraalkoxysilane as a raw material of the photocatalytic coating liquid 2 and causing a hydrolysis reaction to proceed in the preparation of the photocatalytic coating liquid 2. The alcohol produced by the hydrolysis reaction may be contained in the photocatalytic coating liquid 2.

An organic functional group of the silane coupling agent as a raw material of the dehydration condensate or the hydrolyzate is not particularly limited, and examples thereof include an epoxy group and a methacryl group. Examples of commercially available silane coupling agents that can be used as a raw material include product names: KBE-403, KBM-403, KBM-303, KBE-503, KBM-4803, X-12-981S, KBM-1003, KBM-1083, KBM-5103, KBE-903, KBE-603, KBE-573, KBM-803, KBE-9007N, and X-12-967C, available from Shin-Etsu Chemical Co., Ltd. In addition, examples of commercially available silicone resins that can be used as a raw material include: products available from Dow Corning Toray Co., Ltd., such as BA2400, BA2410, BA2411, BA2510, BA2405, 840RESIN, and 804RESIN; and products available from Shin-Etsu Chemical Co., Ltd., such as KR350, KR271, KR272, KR274, KR216, KR280, KR282, KR261, KR260, KR255, KR266, KR251, KR155, KR152, KR214, KR220, X-4040-171, KR201, KR5202, and KR3093.

A proportion of the binder in the photocatalytic coating liquid 2 is 0.05 wt. % or more and 0.5 wt. % or less, and preferably 0.1 wt. % or more and 0.5 wt. % or less. When the proportion of the binder is set to 0.05 wt. % or more, adhesive strength between the photocatalytic particles in the photocatalyst layer 16 and adhesive strength between the photocatalytic particles and the base material 14 can be increased, and the photocatalyst layer 16 having excellent contact resistance can be formed. In addition, when the proportion of the binder is set to 0.5 wt. % or less, it is possible to suppress that the photocatalytic particles are buried in the binder in the photocatalyst layer 16 to lower the photocatalytic activity.

The metal ion contained in the photocatalytic coating liquid 2 is, for example, a copper ion, a silver ion, an iron ion, a zinc ion, or the like. The metal ion contained in the photocatalytic coating liquid 2 may be a cation. The metal ion contained in the photocatalytic coating liquid 2 may be generated by dissolving a metal salt as a raw material in an aqueous dispersion medium. When the photocatalytic coating liquid 2 contains the metal ion, the secondary particle size of the photocatalytic particles can be increased, and it is possible to suppress that the photocatalytic particles are buried in the binder in the photocatalyst layer 16 to lower the photocatalyst activity. Although the principle of the metal ion promoting aggregation of the primary particles of the photocatalytic particles is not clear, it is probable that an electrostatic interaction occurs in a plurality of tungsten oxide particles (photocatalytic particles) which are likely to be negatively charged due to the action of the metal ion which is a cation.

The metal salt as a raw material of the metal ion contained in the photocatalytic coating liquid 2 is not particularly limited as long as it is soluble in the aqueous dispersion medium of the photocatalytic coating liquid 2, and examples thereof include copper nitrate, copper acetate, copper chloride, copper gluconate, copper sulfide, silver nitrate, silver chloride, iron chloride, iron sulfate, iron nitrate, iron sulfide, and zinc gluconate.

A concentration (mass proportion) of the metal ion in the photocatalytic coating liquid 2 is 100 ppm or more and 300 ppm or less. When the concentration of the metal ion is set to 100 ppm or more, the secondary particle size of the photocatalytic particles can be increased, and it is possible to suppress that the photocatalytic particles are buried in the binder in the photocatalyst layer 16 to lower the photocatalytic activity. In addition, when the concentration of the metal ion is set to 300 ppm or less, it is possible to suppress that the secondary particle size of the photocatalytic particles becomes too large, and thus it is possible to cause many of the primary particles constituting the secondary particles to generate photocatalytic activity.

### Photocatalytic Spray Can

A photocatalytic spray can 20 of the present embodiment includes the photocatalytic coating liquid 2, a propellant, and a spray container 3 that stores the photocatalytic coating liquid 2 and the propellant, and the spray container 3 has a spray hole 7 provided to spray the photocatalytic coating liquid 2 together with the propellant. The photocatalytic spray can 20 may be an aerosol spray.

The photocatalytic spray can 20 is provided to discharge the photocatalytic coating liquid 2 inside the spray container 3 (aerosol container) to the outside of the spray container 3 by a pressure of the propellant. When the photocatalytic coating liquid 2 is discharged toward a target (for example, the base material 14) by using the photocatalytic spray can 20, the photocatalyst layer 16 containing photocatalytic particles is formed on the surface of the target, and the target can be uniformly coated with the photocatalyst layer 16.

The spray container 3 is a container of the photocatalytic spray can 20, and includes a pressure-resistant container 9 for storing the photocatalytic coating liquid 2 and the propellant, a valve member 5, an actuator 4, a tube 6, and the like. The valve member 5 can include a stem, a stem hole, a stem gasket, and the like.

In a state where a head portion of the actuator 4 is not pressed, the stem gasket closes the stem hole, and the inside of the spray container 3 is in a sealed state.

When the head portion of the actuator 4 is pressed, the stem and the stem gasket are lowered to open the stem hole, and a flow path for the photocatalytic coating liquid 2 is connected to the spray hole 7. The inside of the spray container 3 is kept at a high pressure by the propellant, and thus, the photocatalytic coating liquid 2 flows through the flow path of the tube 6, the valve member 5, and the actuator 4 by this pressure and is jetted from the spray hole 7. The hole diameter of the spray hole 7 is preferably 0.3 mm or less.

The propellant is a component for increasing the pressure inside the spray container 3, and contains dimethyl ether. A boiling point of dimethyl ether is −24.8° C., and dimethyl ether is put into the spray container 3 as a liquefied gas. Thus, in the spray container 3, a part of dimethyl ether is dissolved in the photocatalytic coating liquid 2 or is present as a liquid, and a part of dimethyl ether is present as a gas in a gas phase 8. The propellant is put in the spray container 3 in such an amount that the internal pressure of the spray container 3 is 0.40 MPa or more at 25° C.

The photocatalytic spray can 20 can be produced by a usual aerosol spray production method. The spray container 3 is formed by filling a bottomed cylindrical container made of aluminum or a tin plate with the photocatalytic coating liquid 2, and then clinching an aerosol valve to an opening at the upper end of the container via a gasket to fill the propellant up to a predetermined liquid amount. In addition, to adjust the internal pressure of the spray container 3, a compressed gas such as carbon dioxide gas, nitrogen gas, compressed air, or oxygen gas can be used as a pressurizing agent. The internal pressure of the photocatalytic spray can 20 is preferably 0.40 MPa or more at a temperature of 25° C.

### Preparation of Photocatalytic Coating Liquid

Photocatalytic coating liquids of Examples 1 to 14 and Comparative Examples 1 to 8 were prepared. Table 1 shows a primary particle size of the photocatalytic particles, a proportion of the photocatalytic particles, the silane coupling agent, a proportion (addition proportion) of the silane coupling agent, the metal salt, and a proportion of the metal ion in each of Examples 1 to 11 and Comparative Examples 1 to 4. Table 2 shows a proportion (addition proportion) of the silane coupling agent, a proportion of the photocatalytic particles, a proportion of copper gluconate, and a copper ion concentration in each of Examples 12 to 14 and Comparative Examples 5 to 8.

### Example 1

A slurry (dispersion medium: water) in which tungsten oxide photocatalytic particles (WO₃ particles) having an average particle size of primary particles of 30 nm were dispersed, a silane coupling agent having an epoxy group (KBE-403 available from Shin-Etsu Chemical Co., Ltd.), copper gluconate, and water were mixed to prepare a photocatalytic coating liquid containing 2.0 wt. % of photocatalytic particles, 0.3 wt. % of the silane coupling agent (addition proportion), and 140 ppm of the copper ion. The silane coupling agent is hydrolyzed during the preparation to produce a binder.

The average particle size of primary particles of the photocatalytic particles was calculated by measuring a specific surface area of the photocatalytic particles obtained by drying the slurry by a BET method and converting the specific surface area using a true spherical model.

The copper ion is produced by dissolving copper gluconate in water.

### Example 2

A photocatalytic coating liquid was prepared in the same manner as in Example 1 except that tungsten oxide photocatalytic particles having an average particle size of primary particles of 10 nm were used.

### Example 3

A photocatalytic coating liquid was prepared in the same manner as in Example 1 except that tungsten oxide photocatalytic particles having an average particle size of primary particles of 50 nm were used.

### Example 4

A photocatalytic coating liquid was prepared in the same manner as in Example 1 except that the proportion of the photocatalytic particles contained in the photocatalytic coating liquid was 5.0 wt. %.

### Example 5

A photocatalytic coating liquid was prepared in the same manner as in Example 1 except that the proportion of the photocatalytic particles contained in the photocatalytic coating liquid was 1.0 wt. %.

### Example 6

A photocatalytic coating liquid was prepared in the same manner as in Example 1 except that the proportion (addition proportion) of the silane coupling agent was 0.5 wt. %.

### Example 7

A photocatalytic coating liquid was prepared in the same manner as in Example 1 except that the proportion (addition proportion) of the silane coupling agent was 0.1 wt. %.

### Example 8

A photocatalytic coating liquid was prepared in the same manner as in Example 1 except that the concentration of the copper ion contained in the photocatalytic coating liquid was 300 ppm.

### Example 9

A photocatalytic coating liquid was prepared in the same manner as in Example 1 except that the concentration of the copper ion contained in the photocatalytic coating liquid was 100 ppm.

### Example 10

A photocatalytic coating liquid was prepared in the same manner as in Example 1 except that a silane coupling agent having a methacryl group (KBE-503 available from Shin-Etsu Chemical Co., Ltd.) was used instead of the silane coupling agent having an epoxy group.

### Example 11

A photocatalytic coating liquid was prepared in the same manner as in Example 1 except that iron chloride II tetrahydrate was used instead of copper gluconate and the photocatalytic coating liquid contained an iron ion instead of the copper ion.

### Example 12

A photocatalytic coating liquid was prepared in the same manner as in Example 1 except that the proportion (addition proportion) of the silane coupling agent was 0.2 wt. % and the concentration of the copper ion contained in the photocatalytic coating liquid was 126 ppm.

### Example 13

A photocatalytic coating liquid was prepared in the same manner as in Example 1 except that the proportion (addition proportion) of the silane coupling agent was 0.2 wt. % and the concentration of the copper ion contained in the photocatalytic coating liquid was 182 ppm.

### Example 14

A photocatalytic coating liquid was prepared in the same manner as in Example 1 except that the proportion (addition proportion) of the silane coupling agent was 0.2 wt. % and the concentration of the copper ion contained in the photocatalytic coating liquid was 280 ppm.

### Comparative Example 1

A photocatalytic coating liquid was prepared in the same manner as in Example 1 except that tungsten oxide photocatalytic particles having an average particle size of primary particles of 100 nm were used.

### Comparative Example 2

A silane coupling agent having an epoxy group (KBE-403 available from Shin-Etsu Chemical Co., Ltd.), copper gluconate, and water were mixed to prepare a coating liquid containing 0.3 wt. % of the silane coupling agent (addition proportion) and 140 ppm of copper ion (no photocatalytic particle was added). The silane coupling agent is hydrolyzed during the preparation to produce a binder.

### Comparative Example 3

A slurry (dispersion medium: water) in which tungsten oxide photocatalytic particles having an average particle size of primary particles of 30 nm were dispersed, copper gluconate, and water were mixed to prepare a photocatalytic coating liquid containing 2.0 wt. % of the photocatalytic particles and 140 ppm of the copper ion (no silane coupling agent was added).

### Comparative Example 4

A slurry (dispersion medium: water) in which tungsten oxide photocatalytic particles having an average particle size of primary particles of 30 nm were dispersed, a silane coupling agent having an epoxy group (KBE-403 available from Shin-Etsu Chemical Co., Ltd.), and water were mixed to prepare a photocatalytic coating liquid containing 2.0 wt. % of the photocatalytic particles and 0.3 wt. % of the silane coupling agent (addition proportion) (no metal salt was added). The silane coupling agent is hydrolyzed during the preparation to produce a binder.

### Comparative Example 5

A slurry (dispersion medium: water) in which tungsten oxide photocatalytic particles having an average particle size of primary particles of 30 nm were dispersed, a silane coupling agent having an epoxy group (KBE-403 available from Shin-Etsu Chemical Co., Ltd.), and water were mixed to prepare a photocatalytic coating liquid containing 2.0 wt. % of the photocatalytic particles and 0.2 wt. % of the silane coupling agent (addition proportion) (no metal salt was added). The silane coupling agent is hydrolyzed during the preparation to produce a binder.

### Comparative Example 6

A photocatalytic coating liquid was prepared in the same manner as in Example 1 except that the proportion (addition proportion) of the silane coupling agent was 0.2 wt. % and the concentration of the copper ion contained in the photocatalytic coating liquid was 70 ppm.

### Comparative Example 7

A photocatalytic coating liquid was prepared in the same manner as in Example 1 except that the proportion (addition proportion) of the silane coupling agent was 0.2 wt. % and the concentration of the copper ion contained in the photocatalytic coating liquid was 350 ppm.

### Comparative Example 8

A photocatalytic coating liquid was prepared in the same manner as in Example 1 except that the proportion (addition proportion) of the silane coupling agent contained in the photocatalytic coating liquid was 0.2 wt. % and the concentration of the copper ion contained in the photocatalytic coating liquid was 420 ppm.

### Measurement of Secondary Particle Size of Photocatalytic Particles

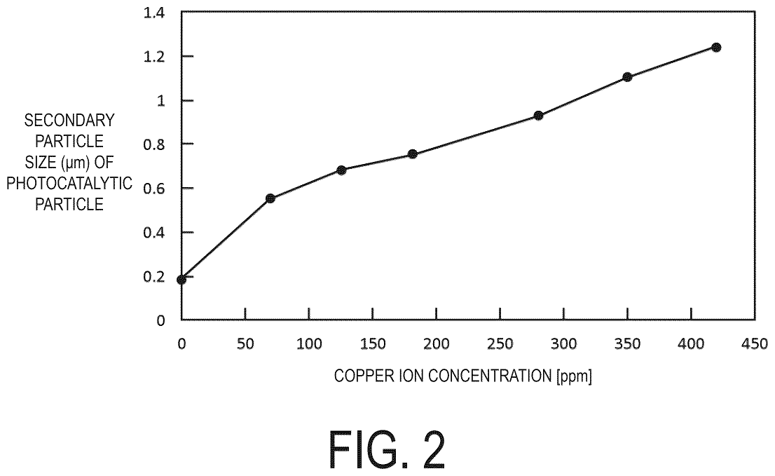

The secondary particle size of the photocatalytic particles contained in each of the photocatalytic coating liquids of Examples 1 to 14 and Comparative Examples 1 to 8 was measured using a laser diffraction/scattering particle size distribution measuring apparatus. The measurement results are presented in Table 2 and Table 3. FIG. 2 is a graph showing changes in secondary particle size of the photocatalytic particles with respect to the concentration of the copper ion contained in the photocatalytic coating liquids of Examples 12 to 14 and Comparative Examples 5 to 8. As can be seen from FIG. 2, it has been found that the secondary particle size of the photocatalytic particles contained in the photocatalytic coating liquid increases when the concentration of the copper ion contained in the photocatalytic coating liquid increases. Although the reason for this is not clear, it is probable that the copper ion, which is a cation, promotes aggregation of the photocatalytic particles including the tungsten oxide particles whose surfaces are likely to be negatively charged.

### Acetaldehyde Gas Decomposition Experiment 1

On an ABS resin plate (100 mm×100 mm), 2 g of the photocatalytic coating liquid of any one of Examples 1 to 11 and Comparative Examples 1 to 4 was evenly dropped using a dropper. The photocatalytic coating liquid dropped on the ABS resin plate was dried with an air dryer at 40° C. to form a photocatalyst layer, and the photocatalyst layer was pre-irradiated with blue LED light of 4500 lux for 48 hours to prepare a test sample. Next, the test sample was put into a 1-L transparent gas bag, and then 100 ppm of acetaldehyde gas was put into the gas bag. The photocatalyst layer was irradiated with blue LED light of 4500 lux from the outside of the gas bag for 5 hours, after which an acetaldehyde gas concentration in the gas bag was measured with a detection tube.

Then, a gas residual rate was calculated using the equation: (gas residual rate)=(gas concentration after 5 hours)/(initial gas concentration 100 ppm). Table 3 shows evaluation of gas decomposition characteristics of each test sample (Examples 1 to 11 and Comparative Examples 1 to 4) based on the gas residual rate.

In evaluation of the gas decomposition characteristics in Table 3, evaluation of a sample in which the gas residual rate was less than 5% was indicated by “Excellent”, evaluation of a sample in which the gas residual rate was 5% or more and less than 20% was indicated by “Good”, evaluation of a sample in which the gas residual rate was 20% or more and less than 50% was indicated by “Fair”, and evaluation of a sample in which the gas residual rate was 50% or more was indicated by “Poor”.

The evaluation of the gas decomposition characteristics of each of Examples 1 to 11 and Comparative Example 3 was “Excellent”, “Good”, or “Fair”, and it was found that the gas decomposition characteristics were sufficient.

The evaluation of the gas decomposition characteristics of Comparative Example 1 was “Poor”. This is probably because the primary particle size of the photocatalytic particles contained in the photocatalytic coating liquid of Comparative Example 1 is 100 nm and is relatively large.

The evaluation of the gas decomposition characteristics of Comparative Example 2 was “Poor”. This is probably because the photocatalytic coating liquid of Comparative Example 2 contains no photocatalytic particle.

The evaluation of the gas decomposition characteristics of Comparative Example 4 was “Poor”. This is probably because the photocatalytic coating liquid of Comparative Example 4 contains no metal salt and the secondary particle size of the photocatalytic particles is relatively small.

### Rubbing Fastness Test

On an ABS resin plate (30 mm×300 mm), the photocatalytic coating liquid of any one of Examples 1 to 11 and Comparative Examples 1 to 4 was uniformly sprayed and applied by a spray to have 0.4 g/m². The photocatalytic coating liquid on the ABS resin plate was dried for 24 hours with a blow dryer at 40° C. to form a photocatalyst layer, thereby preparing a test sample. The test sample was attached to a horizontal test piece table of AB-301 Color Fastness Rubbing Tester available from Tester Sangyo Co., Ltd., BEMCOT M-1 available from Asahi Kasei Corporation was attached to the tip of a rubbing element, and the photocatalyst layer was rubbed back and forth 100 times (rubbing) with BEMCOT M-1 at a speed of 30 times per minute back and forth for 100 mm by 200 gf of weight. After the rubbing, surfaces of the rubbed portion and the non-rubbed portion of the sample were observed using a digital microscope VHX-1000 available from Keyence Corporation, and the state of the photocatalyst layer and the area of the photocatalyst layer were confirmed. The residual rate of the photocatalyst layer was calculated by the following equation.

(Residual rate of photocatalyst layer)=(area of photocatalyst layer in rubbed portion)/(area of photocatalyst layer in non-rubbed portion)

Table 3 shows evaluation of contact resistance of each test sample (Examples 1 to 11 and Comparative Examples 1 to 4) based on the residual rate of the photocatalyst layer and the like.

In the evaluation of the contact resistance in Table 3, evaluation of a sample in which the photocatalyst layer was not damaged and the boundary between the rubbed portion and the non-rubbed portion was not confirmed was indicated by “Excellent”, evaluation of a sample in which the surface of the photocatalyst layer was glossy and the boundary between the rubbed portion and the non-rubbed portion was confirmed but the photocatalyst layer was not clearly shaved or stretched was indicated by “Good”, evaluation of a sample in which shaving or stretching of the photocatalyst layer was confirmed but 40% or more of the photocatalyst layer remained was indicated by “Fair”, and evaluation of a sample in which the residual rate of the photocatalyst layer was less than 40% was indicated by “Poor”.

The contact resistance of each of Examples 1 to 11 and Comparative Examples 1, 2, and 4 was evaluated as “Excellent”, “Good”, or “Fair”, and it was found that the contact resistance was sufficient.

The contact resistance of Comparative Example 3 was evaluated as “Poor”. This is probably because the photocatalytic coating liquid of Comparative Example 3 contains no binder.

### Comprehensive Evaluation

Table 3 also shows comprehensive evaluation of Examples 1 to 11 and Comparative Examples 1 to 4.

In the comprehensive evaluation in Table 3, evaluation of a sample in which both the evaluation of the gas decomposition characteristics and the evaluation of the contact resistance were “Excellent” was indicated by “Excellent”, evaluation of a sample in which the evaluation of the gas decomposition characteristics and the evaluation of the contact resistance were neither “Poor” nor “Fair” but at least one was “Good” was indicated by “Good”, evaluation of a sample in which the evaluation of the gas decomposition characteristics and the evaluation of the contact resistance were not “Poor” but at least one “Fair” was present was indicated by “Fair”, and evaluation of a sample in which at least one of the evaluation of the gas decomposition characteristics and the evaluation of the contact resistance was “Poor” was indicated by “Poor”.

### Acetaldehyde Gas Decomposition Experiment 2

On a cellulose fabric (125 mm×125 mm), 2 g of the photocatalytic coating liquid of any one of Examples 12 to 14 and Comparative Examples 5 to 8 was evenly dropped using a dropper. The cellulose fabric was dried with an air dryer at 40° C. to form a photocatalyst layer, and the photocatalyst layer was pre-irradiated with blue LED light of 4500 lux for 48 hours to prepare a test sample. Next, the test sample was put into a 1-L transparent gas bag, and then 50 ppm of acetaldehyde gas was put into the gas bag. The photocatalyst layer was irradiated with blue LED light of 4500 lux from the outside of the gas bag for 15 minutes, after which an acetaldehyde gas concentration in the gas bag was measured with a detection tube.

Then, the gas removal rate was calculated from the equation: (gas removal rate)=1−(gas concentration after 15 minutes)/(initial gas concentration 50 ppm).

Table 2 shows acetaldehyde concentrations (concentrations after irradiation with light for 15 minutes) measured in the acetaldehyde gas decomposition experiment 2 of Examples 12 to 14 and Comparative Examples 5 to 8 and the calculated gas removal rates.

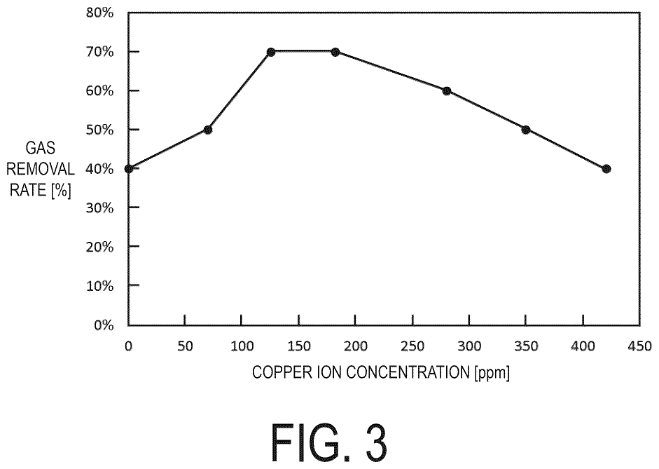

FIG. 3 is a graph showing changes in gas removal rate with respect to the concentration of copper ion contained in the photocatalytic coating liquids of Examples 12 to 14 and Comparative Examples 5 to 8.

As can be seen from FIG. 3, it was found that the gas removal rate was increased when the concentration of the copper ion contained in the photocatalytic coating liquid was set to 100 ppm or more and 300 ppm or less. It is probable that when the copper ion concentration is too low, the secondary particle size of the photocatalytic particles becomes small, and the photocatalytic particles are buried in the binder in the photocatalyst layer. Probably, this lowered the gas removal rate. It is probable that when the copper ion concentration is too high, the secondary particle size of the photocatalytic particles is too large, and light does not reach central portions of secondary particles of the photocatalytic particles. Probably, this lowered the gas removal rate.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A photocatalytic coating liquid comprising:
1.0 wt. % or more and 5.0 wt. % or less of photocatalytic particles;
0.05 wt. % or more and 0.5 wt. % or less of a binder;
a metal ion; and
an aqueous dispersion medium,
wherein
the photocatalytic particles comprise tungsten oxide particles,
an average particle size of primary particles is 10 nm or more and 50 nm or less, the average particle size being converted from a BET specific surface area of the photocatalytic particles using a true spherical model, and
an average particle size D50 of secondary particles of the photocatalytic particles is 600 μm or more and 1000 μm or less.

2. The photocatalytic coating liquid according to claim 1, wherein a concentration of the metal ion in the photocatalytic coating liquid is 100 ppm or more and 300 ppm or less.

3. The photocatalytic coating liquid according to claim 1, wherein the binder has an inorganic skeleton composed of a siloxane bond or a silanol group.

4. The photocatalytic coating liquid according to claim 1, wherein the metal ion contains at least one of a copper ion, a silver ion, an iron ion, and a zinc ion.

5. A photocatalytic spray can comprising:
the photocatalytic coating liquid according to claim 1;
a propellant; and
a spray container that stores the photocatalytic coating liquid and the propellant, wherein
the spray container has a spray hole provided to spray the photocatalytic coating liquid together with the propellant.

6. The photocatalytic spray can according to claim 5, wherein
the propellant comprises dimethyl ether,
a hole diameter of the spray hole is 0.3 mm or less, and
an internal pressure of the spray container is 0.4 MPa or more at a temperature of 25° C.
